(19) United States
(12) Patent Application Publication
(10) Pub. No.: US 2009/0059564 A1
(43) Pub. Date: Mar. 5, 2009

(54) Light Diffusion Plate and Backlight Device

(75) Inventors: Keisuke Tsukada, Tokyo (JP); Masahiko Hayashi, Tokyo (JP); Noboru Muraoka, Tokyo (JP)

Correspondence Address: BIRCH STEWART KOLASCH & BIRCH, PO BOX 747, FALLS CHURCH, VA, 22040-0747, US

(73) Assignee: Zeon Corporation, TOKYO (JP)

(21) Appl. No.: 11/992,643

(22) PCT Filed: Sep. 27, 2006
(86) PCT No.: PCT/JP2006/319124

§ 371 Date: Apr. 25, 2008

(30) Foreign Application Priority Data
Sep. 28, 2005 (JP) 2005-282823
Jan. 12, 2006 (JP) 2006-005289

(51) Int. Cl. G09F 13/08; G02B 5/02

(52) U.S. Cl. 362/97.1; 359/599

(57) ABSTRACT

The light diffusion plate 30 of the present invention has a rectangular shaped main body 31 including a part forming the effective surface of a backlight device 1 and a peripheral edge part 32 formed at an outer circumferential part of the main body 31 and forming a non-effective surface of the backlight device 1. The main body 31 has a diagonal length of 500 mm or more. The peripheral edge part 32 is formed with a rectangular shaped boundary line 30X for adjusting the position of the light diffusion plate 30 with respect to the housing 20. The housing 20 is formed with arrows 21X and 21Y for alignment with two sides A and B of one corner of the rectangular shaped boundary line 30X.

### TECHNICAL FIELD

The present invention relates to a light diffusion plate and backlight device, more particularly relates to a light diffusion plate able to be arranged positioned much more accurately with respect to a housing and to a backlight device provided with this light diffusion plate.

### BACKGROUND ART

In the past, as a backlight device for a liquid crystal display, the edge light type and the direct type have been used. For example, the general direct type backlight device is comprised of a plurality of linear light sources arranged in parallel, a housing holding the linear light sources, and a light diffusion plate arranged at an emitting surface side of the housing. At the inside of a bottom surface of the housing, a reflection plate reflecting light from the linear light sources is provided. In this direct type backlight device, the direct light emitted from the linear light sources and the reflected light reflected at the reflection plate are emitted after being diffused by a light diffusion plate, so the light diffusion plate functions as a light emitting surface (for example, see Japanese Patent Publication (A) No. 2004-127680).

In the direct type backlight device, when setting the light diffusion plate in the housing, in general the housing is formed with tabs at the inside surface of the outer circumferential part, slots are formed at the outer circumferential part of the light diffusion plate, and the tabs and slots are engaged so as to position the light diffusion plate with respect to the housing.

### DISCLOSURE OF THE INVENTION

However, a light diffusion plate sometimes expands due to heat from the linear light sources, absorption of humidity, etc., so a predetermined clearance is provided between the tabs and slots. For this reason, a light diffusion plate can become deviated in position somewhat. In particular, if the light diffusion plate becomes larger in dimensions (for example, in the case of a diagonal of 500 mm or more), the degree of that positional deviation becomes more remarkable. Further, for the light diffusion plate, sometimes one provided on its surface with a prism array having linear prisms along the longitudinal direction of the linear light sources is used. In such a light diffusion plate, to enable the prism array to diffuse the light in a predetermined direction, it is required that the linear light sources and prism array be accurately positioned in orientation. From the above, in a light diffusion plate, the light diffusion plate being able to be more accurately positioned with respect to the housing or linear light sources is required.

An object of the present invention is to provide a light diffusion plate able to be arranged much more accurately positioned with respect to a housing and a backlight device provided with this light diffusion plate.

The present invention provides a light diffusion plate used in a backlight device provided with a linear light source, a housing holding this linear light source, and a light diffusion plate arranged at an emitting surface side of this housing and diffusing and emitting light from the linear light source, the light diffusion plate having a rectangular shaped main body including a part forming an effective surface of the backlight device and a peripheral edge part formed at an outer circumferential part of the main body and forming anon-effective surface of the backlight device, the main body having a diagonal length of 500 mm or more, and the peripheral edge part formed with a positioning part for adjusting a position of that light diffusion plate with respect to the housing.

According to the present invention, since the peripheral edge part is formed with the positioning part for adjusting the position with respect to the housing, for example, by providing the inside of the housing with marks etc. corresponding to the positioning part and matching the positioning part and marks, it becomes possible to much more accurately position the light diffusion plate compared with the case of positioning by the outer shape using tabs and slots like in the past. In particular, since the diagonal length of the main body forming the light diffusion plate is made 500 mm or more, the effect of the positioning becomes much more remarkable. Note that when the diagonal length is 700 mm or more, the effect of the positioning becomes further remarkable.

Further, after forming a light diffusion plate, its front surface is inspected. At this time, for example, the light diffusion plate is inspected by a noncontact system emitting laser light to the surface. With this inspection, the front surface position of the light diffusion plate has to be accurately recognized, but in the past sometimes diffuse reflection inside the light diffusion plate made it impossible to recognize well the front surface position of the light diffusion plate. However, according to the present invention, by providing the positioning part at the front surface of the light diffusion plate, the positioning part can be used to reliably recognize the front surface position of the light diffusion plate, so the light diffusion plate can be inspected much more efficiently and with a high precision.

Here, preferably the light diffusion plate is formed using an injection molding mold having a core plate for forming the main body and side frames arranged abutting against the outer circumferential ends of the core plate and forming the peripheral edge part, and the positioning part is a rectangular shaped boundary line formed by a step difference at the abutting part of the core plate and the side frames. At this time, the step difference has a height of preferably 1 μm or more, more preferably 3 μm or more, still more preferably 5 μm or more. Further, the step difference preferably has a height of not more than ¼ of the thickness of the obtained light diffusion plate due to the ease of damaging other light diffusion plates.

If configured in this way, it is possible to simply form a boundary line serving as the positioning part by just providing a step difference of predetermined dimensions between the core plate and the side frames. Further, since the positioning part is formed into a rectangular shape, the non-effective surface of the light diffusion plate can be easily grasped. For this reason, for example, when gripping the light diffusion plate by the two hands or fixtures etc. for inspection of the quality etc., it is possible to simply obtain a grasp of the gripping position while viewing the position of the boundary line, so it is possible to simply perform inspection without damaging the effective surface. Furthermore, since it is possible to simply obtain a grasp of the effective surface of the light diffusion plate using the positioning part for the mark, the range of inspection of the light diffusion plate is clarified and inspection can be made more efficient.

Further, when forming a light diffusion plate of a different outer shape, it is possible to form it by changing to a peripheral edge part with a different outer shape. At this time, since the same core plate would be used, even if forming a light diffusion plate with a different outer shape, the surface of the light diffusion plate would be provided with a positioning part of the same dimensions. For this reason, for example, by setting the inspection start position of an inspection system based on the dimensions and position of the positioning part, it would be possible to perform inspection simply under the same conditions as the case of setting for each different outer shape.

Further, preferably, in the above light diffusion plate, the light diffusion plate is formed using an injection molding mold having a core plate for forming the main body and side frames arranged abutting against the outer circumferential ends of the core plate and forming the peripheral edge part, and the positioning part is a rectangular shaped boundary line formed into a projecting shape by the clearance between the core plate and the side frames. In such a configuration as well, it is possible to obtain effects similar to the case of the above step difference.

Here, the projection forming the boundary line has a width of preferably 1 μm or more, more preferably 3 μm or more, still more preferably 5 μm or more. Further, the projection forming the boundary line has a height of preferably 1 μm or more, more preferably 3 μm or more, still more preferably 5 μm or more. Further, the projection forming the boundary line preferably has a height of not more than ¼ of the thickness of the obtained light diffusion plate due to the ease of damaging other light diffusion plates or the ease of breakage of the projection itself.

Here, the “width of the projection forming the boundary line” means the width of the root part of the projection. Further, the “height of the projection” means the maximum height from the root part.

According to this configuration having the projection shaped boundary line, it is possible to simply form the projection shaped boundary line serving as a positioning part by just providing a clearance of predetermined dimensions between the core plate and the side frames. Further, the positioning part can be formed into a rectangular shape, so it is possible to easily obtain a grasp of the non-effective surface of the light diffusion plate. For this reason, for example, when gripping the light diffusion plate by the two hands or fixtures etc. for inspection of the quality etc., it is possible to simply obtain a grasp of the gripping position while viewing the position of the boundary line, so it is possible to simply perform inspection without damaging the effective surface. Furthermore, in the same way as above, inspection of the effective surface becomes easy.

Further, preferably the housing is provided with marks for alignment with the two sides of a corner part of the boundary line formed into a rectangular shape. Here, as the “marks”, it is possible to use arrows, lines, etc. showing positions corresponding to the sides of the corner part.

If configured in this way, by just aligning the two sides of the corner of the boundary line and the marks corresponding to the sides, it is possible to accurately and simply arrange the light diffusion plate without worrying about the positions of the other corner parts etc. Further, since the main body has a diagonal dimension of a large 500 mm or more, when arranging the diffusion plate, dust etc. adhering to the worker is liable to drop to and stick on the main body, but according to this configuration, the worker does not have to lean over the main body and concern himself with the positioning of the corner part at the diagonal position, so it is possible to reliably prevent dropping and sticking of dust etc. to the main body.

Preferably, in the above light diffusion plate, the main body is formed with a prism array having a plurality of linear prisms extending substantially parallel to the longitudinal direction of the linear light source. If configured in this way, since it is necessary to more accurately position the prism array and the linear light source in orientation, this is suitable for the present invention enabling more accurate positioning. Further, since the positioning part is provided at only one surface of the light diffusion plate, it is possible to reliably judge the front and back surfaces of the light diffusion plate by using this positioning part as a mark. For this reason, even if forming the prism array on the front surface of the light diffusion plate, it is possible to reliably form the desired light diffusion plate without mistaking the front and back surfaces.

In the above light diffusion plate, the main body may be formed with a patterned part having repeated recessed structures or projecting structures having three or more surfaces, and the recessed structures or projecting structures may have a maximum height Rz of 1,000 μm or less. If configured in this way, the light diffusion plate can be improved in luminance uniformity. Note that the maximum height Rz can be found based on the Japan Industrial Standard JIS B 0601.

At this time, the recessed structures or projecting structures preferably have pyramidal or truncated pyramidal shapes. If configured in this way, since the recessed structures or projecting structures are relatively simple in shapes, the patterned part is easily formed.

In such a light diffusion plate, the patterned part may have repeated projecting structures, and the projecting structures may be formed by cutting into the prism array having the plurality of linear prisms along a direction perpendicularly intersecting the longitudinal direction of the linear prisms in V-cross-sectional shapes. Further, in such a light diffusion plate, the patterned part may have repeated recessed structures, and the recessed structures may be transferred using a member having projecting structures formed by cutting into the prism array having the plurality of linear prisms along a direction perpendicularly intersecting the longitudinal direction of the linear prisms in V-cross-sectional shapes.

The present invention provides a backlight device provided with the above light diffusion plate. According to the present invention, the light diffusion plate can be positioned much more accurately with respect to the housing, so it is possible to provide a backlight device with a high luminance and a high luminance uniformity.

### BRIEF DESCRIPTION OF THE DRAWINGS

FIG. 1A is a plan view of a backlight device according to the present invention,

FIG. 1B is a vertical cross-sectional view of a backlight device according to the present invention,

FIG. 2 is a view of the state of attachment of a light diffusion plate to a housing in the backlight device shown in FIG. 1A and FIG. 1B,

FIG. 3A is a plan view of a stationary mold forming part of an injection molding mold used in the present invention,

FIG. 3B is a cross-sectional view along the line A-A of a stationary mold forming part of an injection molding mold shown in FIG. 3A,

FIG. 3C is a cross-sectional view along the line B-B of a stationary mold forming part of an injection molding mold shown in FIG. 3A, and

FIG. 4 is a perspective view showing part of the patterned part of a light diffusion plate according to a modification of the present invention.

### BEST MODE FOR CARRYING OUT THE INVENTION

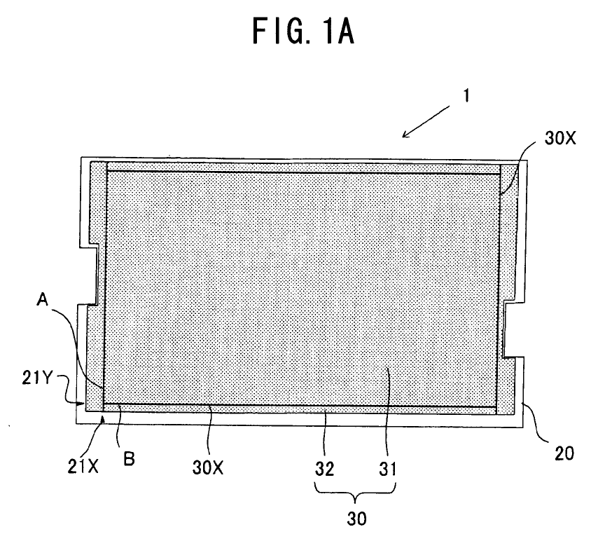

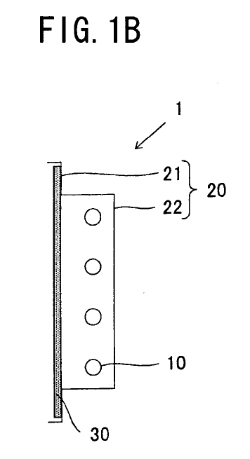

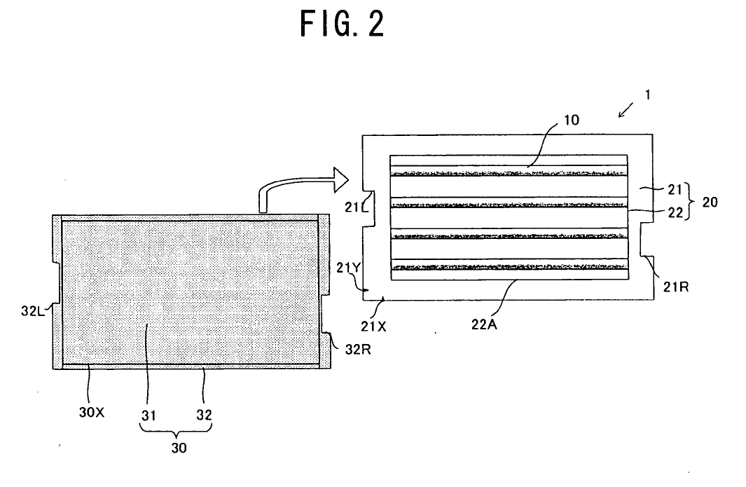

Below, a backlight device using a light diffusion plate according to an embodiment of the present invention will be explained with reference to the drawings. Note that the present invention is not limited by the embodiment shown below. FIG. 1A is a plan view showing a backlight device of the present embodiment, while FIG. 1B is a vertical cross-sectional view of a backlight device. FIG. 2 is a view showing the state of attachment of a light diffusion plate to a housing in the backlight device shown in FIG. 1A and FIG. 1B.

As shown in FIG. 1A, FIG. 1B, and FIG. 2, the backlight device 1 is provided with a plurality of linear light sources 10, a housing 20 holding these linear light sources 10, and a light diffusion plate 30 arranged at an emitting surface side of the housing 20. Note that while the illustration is omitted, the inner side of the bottom surface of the housing 20 is provided with a reflection plate reflecting the light from the linear light sources 10. Such a backlight device 1 diffuses the direct light emitted from the linear light sources 10 and reflected light reflected at the reflecting plate by the light diffusion plate 30 and emits the light in a planar shape to the emitting surface side (in front of paper surface in FIG. 1A, left side in FIG. 1B).

The linear light sources 10 used may be cold cathode fluorescent lamps, hot cathode fluorescent lamps, LEDs arranged in a line, combinations of LEDs and a light guide, etc. Among these, use of cold cathode fluorescent lamps is preferable in terms of the luminance uniformity of the linear light sources 10. Note that, in FIG. 1A, FIG. 1B, and FIG. 2, four linear light sources 10 are shown, but the invention is not particularly limited to that number.

As shown in FIG. 1A and FIG. 1B, the housing 20 is provided with a support part 21 supporting the light diffusion plate 30 and a bulge part 22 where the center part of the support part 21 bulges out to the incident surface side (rear of paper surface in FIG. 1A, right side in FIG. 1B) and forms a substantially rectangular shape with an open emitting surface side when seen by a plan view. As shown in FIG. 2, the left and right side surfaces of the support part 21 are formed with tabs 21L and 21R projecting out to the center. Further, at the bottom left part of the support part 21 in FIG. 2, arrows 21X and 21Y are formed as marks.

At the bulge part 22, the linear light sources 10 are arranged. The open part 22A of the bulge part 22 corresponds to the effective surface of the backlight device 1. Note that the “effective surface” means the surface corresponding to the part exposed to the outside when assembly the backlight device 1 in a display device. Further, the later explained “non-effective surface” is the part other than the effective surface.

The light diffusion plate 30 is formed into a rectangular shape when seen from a plan view. The light diffusion plate 30 is provided with a rectangular shaped main body 31 including a part corresponding to the effective surface and a peripheral edge part 32 formed at the outer circumferential part of the main body 31 and forming the non-effective surface. Note that the main body 31 therefore includes an effective surface and non-effective surface. The main body 31 has a diagonal length of 500 mm or more.

The left and right sides of the peripheral edge 32 are formed with slots 32L and 32R into which the tabs 21L and 21R of the housing 20 fit. Further, the boundary part of the main body 31 and the peripheral edge part 32 are formed with a step difference with a height dimension of 1 μm or more. Note that this step difference is preferably 3 μm or more, more preferably 5 μm or more. The line showing the boundary of this step difference corresponds to the rectangular shaped boundary line 30X of the positioning part.

Here, for the light diffusion plate 30, for example, glass, a mixture of two or more types of difficult to mix resins, a transparent resin into which a light diffusion agent has been dispersed, etc. may be used. Among these as well, for the light diffusion plate 30, due to its being light in weight and due to molding being easy, a resin is preferable. Due to the ease of adjustment of the total light transmission rate and the haze, a transparent resin into which a light diffusion agent has been dispersed is preferably used.

As the transparent resin used for the light diffusion plate 30, for example, polyethylene, a propylene-ethylene copolymer, polystyrene, a copolymer of an aromatic vinyl-based monomer and a (meth)acrylic acid alkyl ester having a lower alkyl group, polyethylene terephthalate, a terephthalic acid-ethylene glycol-cyclohexane dimethanol copolymer, polycarbonate, an acryl resin, a resin having an alicyclic type structure, etc. may be mentioned. Among these, polycarbonate, polystyrene, a copolymer of an aromatic vinyl-based monomer and a (meth)acrylic acid alkyl ester having a lower alkyl group containing 10% or more of the aromatic vinyl-based monomer, a resin having an alicyclic type structure, or other resin having a coefficient of water absorption of 0.25% or less has little deformation due to absorption of moisture, so is preferable in that a large light diffusion plate with little warping can be obtained. A resin having an alicyclic type structure is further preferable in that it has a good fluidity and enables the efficient production of a large-sized light diffusion plate. A compound comprising a resin having an alicyclic type structure and a light diffusion agent is provided with both the high transmission ability and high diffusion ability required for a light diffusion plate and is good in chromaticity, so can be preferably used.

As specific examples of the resin having an alicyclic type structure, (1) a ring-opening polymer of a norbornene-based monomer, a ring-opening copolymer of a norbornene-based monomer and another monomer able to be copolymerized with this by ring-opening copolymerization, their hydrogenates, an addition polymer of a norbornene-based monomer, an addition copolymer of a norbornene-based monomer and another monomer able to be copolymerized with this, or another norbornene-based polymer; (2) a single ring cyclic olefin-based polymer and its hydrogenate; (3) a cyclic conjugated diene-based polymer and its hydrogenate; (4) a polymer of a vinyl alicyclic type hydrocarbon-based monomer, a copolymer of a vinyl alicyclic type hydrocarbon-based monomer and another monomer copolymerizable with this, their hydrogenates, a hydrogenate of a double bond part (including aromatic ring) of a polymer of a vinyl aromatic-based monomer, a hydrogenate of a double bond part (including an aromatic ring) of a copolymer of a vinyl aromatic monomer and another monomer copolymerizable with this, or another vinyl alicyclic type hydrocarbon-based polymer; etc. may be mentioned. Among these, from the viewpoint of the heat resistance, mechanical strength, etc., a norbornene-based polymer and a vinyl alicyclic type hydrocarbon-based polymer are preferable, while a hydrogenate of a ring-opening polymer of a norbornene-based monomer, a hydrogenate of a ring-opening copolymer hydrogenate of a norbornene-based monomer and another monomer copolymerizable with this by ring-opening copolymerization, a hydrogenate of a double bond part (including aromatic ring) of a polymer of a vinyl aromatic-based monomer, and a hydrogenate of a double bond part (including aromatic ring) of a vinyl aromatic monomer and another monomer copolymerizable with the same are further preferable.

Next, the routine for setting the light diffusion plate 30 in the housing 20 will be explained. As shown in FIG. 2, first, a plurality of linear light sources 10 are arranged to become substantially parallel inside the bulge part 22 of the housing 20. Next, the tabs 21L and 21R of the housing 20 and the slots 32L and 32R of the light diffusion plate 30 are engaged. In that state, the light diffusion plate 30 is placed on the support part 21. Next, as shown in FIG. 1A, the two sides A and B of the bottom left corner part of the boundary line 30X in the figure are aligned with the corresponding arrows 21X and 21Y by adjusting the position of the light diffusion plate 30 and fastening the light diffusion plate 30 in position. The light diffusion plate 30 is set in this way.

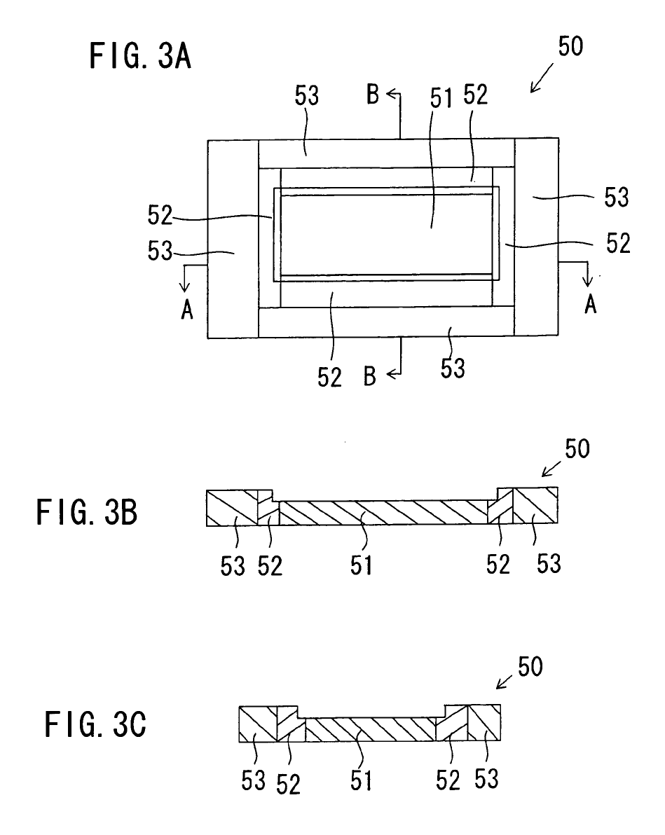

Next, the injection molding mold for producing the light diffusion plate 30 according to the present invention will be explained. FIG. 3A to FIG. 3C are views explaining a stationary mold 50 forming part of an injection molding mold, FIG. 3A is a plan view of the stationary mold 50, FIG. 3B is a cross-sectional view along the line A-A, and FIG. 3C is a cross-sectional view along the line B-B. As shown in FIG. 3A to FIG. 3C, the injection molding mold is provided with a stationary mold 50 and a movable mold (not shown) able to move with respect to this stationary mold 50. The stationary mold 50 is provided with a core plate 51 for forming the main body 31 of the light diffusion plate 30, four side frames 52 at the top, bottom, left, and right arranged abutting against the outer circumferential end of the core plate 51 forming a peripheral edge part 32, and a support block 53 holding the side frames 52.

Between the surface of the core plate 51 and the surfaces of the side frames 52, a step difference having a height dimension of 1 μm or more is formed. Here, either of the surface of the core plate 51 or the surfaces of the side frames 52 may be formed higher, but if considering the ease of taking out the product from the mold after injection molding, it is preferable to form the side frames 52 higher. Further, the step difference was given a height dimension of 1 μm or more, but 3 μm or more is more preferable and 5 μm or more is further preferable. Further, the step difference preferably has a height of not more than ¼ of the thickness of the obtained light diffusion plate in view of the ease of damaging other light diffusion plates. Note that the light diffusion plate 30 is produced by injecting molten resin into the cavity formed by the core plate 51 and side frames 52 and the above movable mold. At this time, the light diffusion plate 30 is formed with a boundary line 30X at a location corresponding to the end of the step difference.

According to the above backlight device 1, by forming a boundary line 30X for adjusting the position relative to the housing 20 at the peripheral edge part 32, forming arrows 21X and 21Y at the housing 20, and aligning the two sides A and B of the corner part of the boundary line 30X with the corresponding arrows 21X and 21Y, it is possible to accurately position and arrange the light diffusion plate 30. At this time, since the diagonal length of the main body 31 of the light diffusion plate 30 was made 500 mm or more, the effect of the positioning appears more remarkably.

Further, by just aligning the two sides A and B of the corner part of the boundary line 30X and the corresponding arrows 21X and 21Y, it is possible to simply arrange the light diffusion plate 30 without worrying about the positioning of the other corner parts etc. Furthermore, since the diagonal dimension of the main body is a large 500 mm or more, when arranging the diffusion plate, the worker might lean over it and dust etc. sticking to the worker might drop on to and stick at the main body, but according to this configuration, there is no need to worry about the positioning of the corner part at the diagonal position, so it is possible to reliably prevent dust etc. from dropping onto and sticking at the main body 31.

Further, by just providing a step difference of predetermined dimensions between the core plate 51 and side frames 52, it is possible to simply form the rectangular shaped boundary line 30X. By visually inspecting this boundary line 30X, it is possible to simply and reliably obtain a grasp of the position of the non-effective surface in the light diffusion plate 30. For this reason, even when holding the light diffusion plate 30 by two hands and inspecting the quality etc., it is possible to simply inspect the plate without damaging the effective surface.

Furthermore, for example, even when inspecting the light diffusion plate by a noncontact system firing laser light at the surface, the positioning part provided on the front surface of the light diffusion plate enables the front surface position of the diffusion plate to be reliably recognized, so the light diffusion plate can be inspected more efficiently and with higher precision.

Note that the present invention is not limited to the above embodiment. In the above embodiment, the light diffusion plate 30 was made a flat plate shape, but for example at least one surface of the light diffusion plate may also be formed with a prism array having a plurality of linear prisms extending substantially in parallel with the longitudinal direction of the linear light source. In this case, a higher precision is sought in the relative positions of the linear light sources and linear prisms in orientation, so the configuration of the present invention is particularly preferable. Note that the linear prism may have a cross-sectional shape of, for example, a triangular shape or trapezoidal shape.

Further, in the above embodiment, the main body 31 is not particularly formed with anything, but, for example, the main body 31 may also be formed with a patterned part of a repetition of recessed structures or projecting structures having three or more faces. The recessed structures or projecting structures may have a maximum height Rz of 1,000 μm or less. If configured in this way, there is the advantage that the recessed structures or projecting structures enable an improvement in the luminance. The recessed structures or projecting structures having three or more faces may for example be made pyramidal or truncated pyramidal shaped structures with three or more side face parts. In this case, there is the advantage that the light diffusion plate able to increase the luminance can be simply made.

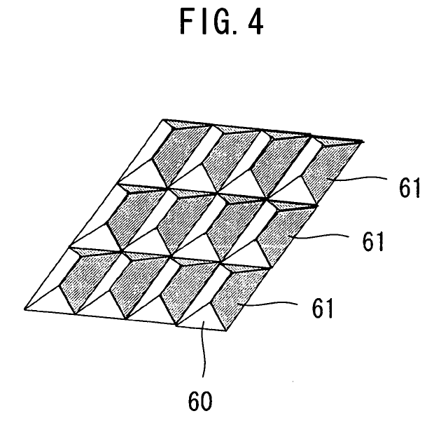

Further, it is possible to make the repeating units forming the patterned part projecting structures and to form these projecting structures by cutting into the prism array having the plurality of linear prisms along a direction perpendicularly intersecting the longitudinal direction of the linear prisms in V-cross-sectional shapes. Such a patterned part may, for example, be made the shape such as shown in FIG. 4. FIG. 4 is a perspective view showing part of the patterned part 60 having a repeated plurality of projecting structures 61. As shown in FIG. 4, the patterned part 60 is formed by cutting into the plurality of linear prisms extending in the substantially top-bottom direction in FIG. 4 and having triangular cross-sectional shapes along the substantially left-right direction in FIG. 4 in V-cross-sectional shapes. Due to this, a plurality of projecting structures 61 are repeatedly formed.

Further, it is possible to make the repeating units forming the patterned part recessed structures and to form these recessed structures by transfer using a member having projecting structures formed by cutting into the prism array having the plurality of linear prisms along a direction perpendicularly intersecting the longitudinal direction of the linear prisms in V-cross-sectional shapes.

In the above embodiment, due to the step difference between the core plate 51 and the side frames 52, a rectangular shaped boundary line forming the positioning part was formed, but for example it is also possible to form the rectangular shaped boundary line by a projection formed by providing some clearance between the core plate 51 and side frames 52 and pouring resin into this clearance. At this time, the projection forming the boundary line has a width of preferably 1 μm or more, more preferably 3 μm or more, still more preferably 5 μm or more and has a height of preferably 1 μm or more, more preferably 3 μm or more, still more preferably 5 μm or more. In such a configuration as well, it is possible to exhibit an effect similar to the case of the step difference in the above embodiment. Further, the projection forming the boundary line preferably has a height of not more than ¼ of the thickness of the obtained light diffusion plate due to the ease of damaging other light diffusion plates and the ease of breakage of the projections themselves.

However, in the above embodiment, at the core plate 51 and side frames 52, to make the surface of the light diffusion plate 50 flat, the surface of the core plate 51 (surface forming front surface of light diffusion plate) and the front surfaces of the side frames 52 (surfaces forming front surface of light diffusion plate) are polished. For this reason, by making the polishing direction of the front surface of the core plate 51 and the polishing direction of the front surfaces of the side frames 52 mutually different directions, it is possible to form a rectangular shaped boundary line between the part of the light diffusion plate 50 corresponding to the core plate 51 and the part corresponding to the side frames 52 and to use this boundary line as the rectangular shaped boundary line for positioning. At this time, the angle formed by the polishing direction of the core plate 51 and the polishing directions of the side frames 52 is preferably about 90°.

Further, in the above embodiment, two arrows 21X and 21Y were formed as marks, but the invention is not limited to this. It is also possible to use two straight lines etc.

According to the present invention, since the positioning part is formed at the peripheral edge part for adjusting the position with respect to the housing, for example by providing marks etc. corresponding to the positioning part at the inside of the housing and aligning the positioning part and marks, there is the effect that it is possible to accurately position and arrange the plate. In particular, since the diagonal length of the main body forming the light diffusion plate was made 500 mm or more, the effect of the positioning becomes more remarkable.

### EXAMPLES

Below, examples will be given to explain the present invention in further detail. Note that the present invention is not limited to the following examples.

### Example 1

In FIG. 3A to FIG. 3C, a stationary mold having a core plate 51 of a vertical 420 mm×horizontal 710 mm dimensions, side frames 52 arranged at top and bottom positions of dimensions of a vertical 5 mm×horizontal 710 mm, and side frames 52 arranged at left and right positions of dimensions of a vertical 430 mm×horizontal 5 mm was used to form a 32 inch light diffusion plate of a thickness of 2 mm. The step difference of the obtained light diffusion plate at the part corresponding to the boundary line of the core plate and side frames was 9 μm. The formed light diffusion plate was used to assemble a direct type backlight device. The boundary line was present inside the non-effective surface of the backlight, so no uneven luminance occurred. Further, by inspecting the plate using the boundary line as a mark, the plate could be inspected more efficiently than the past and assembly was also easy.

### Example 2

In FIG. 3A to FIG. 3C, a stationary mold having a core plate 51 of a vertical 594 mm×horizontal 1014 mm dimensions, side frames 52 arranged at top and bottom positions of dimensions of a vertical 3 mm×horizontal 1014 mm, and side frames 52 arranged at left and right positions of dimensions of a vertical 600 mm×horizontal 3 mm was used to form a 45 inch light diffusion plate of a thickness of 2 mm. The step difference of the obtained light diffusion plate at the part corresponding to the boundary line of the core plate and side frames was 12 μm. The formed light diffusion plate was used to assemble a direct type backlight device. The boundary line was present inside the non-effective surface of the backlight, so no uneven luminance occurred. Further, by inspecting the plate using the boundary line as a mark, the plate could be inspected more efficiently than the past and assembly was also easy.

### Example 3

In FIG. 3A to FIG. 3C, a stationary mold having a core plate 51 of a vertical 420 mm×horizontal 710 mm dimensions, side frames 52 arranged at top and bottom positions of dimensions of a vertical 5 mm×horizontal 710 mm, and side frames 52 arranged at left and right positions of dimensions of a vertical 430 mm×horizontal 5 mm and having spacers provided so that a clearance of 20 μm was formed between the core plate and each of the four side frames was used to form a 32 inch light diffusion plate of a thickness of 2 mm. At the part of the obtained light diffusion plate corresponding to the boundary line of the core plate and the side frames, a rectangular boundary line of a projecting shape of a width of 20 μm and a height of 15 μm was formed. The formed light diffusion plate was used to assemble a direct type backlight device. The boundary line was present inside the non-effective surface of the backlight, so no uneven luminance occurred. Further, by inspecting the plate using the boundary line as a mark, the plate could be inspected more efficiently than the past and assembly was also easy.

Note that this disclosure relates to the matters included in Japanese Patent Application No. 2005-282823 filed on Sep. 28, 2005 and Japanese Patent Application No. 2006-5289 filed on Jan. 12, 2006, all of the disclosures of which are clearly incorporated here as reference matter.

### INDUSTRIAL APPLICABILITY

In this way, the light diffusion plate and backlight device of this invention are suitable for use for a backlight device of a liquid crystal display.

1. A light diffusion plate used in a backlight device provided with a linear light source, a housing holding said linear light source, and a light diffusion plate arranged at an emitting surface side of this housing and diffusing and emitting light from said linear light source,
said light diffusion plate having a rectangular shaped main body including a part forming an effective surface of said backlight device and a peripheral edge part formed at an outer circumferential part of the main body and forming a non-effective surface of said backlight device,
said main body having a diagonal length of 500 mm or more, and
said peripheral edge part formed with a positioning part for adjusting a position of said light diffusion plate with respect to said housing.

2. A light diffusion plate as set forth in claim 1, wherein
said light diffusion plate is formed using an injection molding mold having a core plate for forming said main body and a side frame arranged abutting against an outer circumferential end of said core plate and forming said peripheral edge, and
said positioning part is a rectangular shaped boundary line formed by a step difference at the abutting part of said core plate and said side frame.

3. A light diffusion plate as set forth in claim 2, wherein said step difference has a height of 1 μm or more.

4. A light diffusion plate as set forth in claim 1, wherein
said light diffusion plate is formed using an injection molding mold having a core plate for forming the main body and a side frame arranged abutting against an outer circumferential end of said core plate and forming said peripheral edge part, and
said positioning part is a rectangular shaped boundary line formed into a projecting shape by the clearance part between said core plate and said side frame.

5. A light diffusion plate as set forth in claim 4, wherein said projection forming the boundary line has a width of 1 μm or more.

6. A light diffusion plate as set forth in claim 4, wherein said projection forming the boundary line has a height of 1 μm or more.

7. A light diffusion plate as set forth in claim 2, wherein said housing is provided with marks for alignment with the two sides of a corner part of said boundary line formed in to a rectangular shape.

8. A light diffusion plate as set forth in claim 1, wherein said main body is formed with a prism array having a plurality of linear prisms extending substantially parallel to the longitudinal direction of said linear light source.

9. A light diffusion plate as set forth in claim 1, wherein said main body is formed with a patterned part having repeated recessed structures or projecting structures, each structure has three or more surfaces, and said recessed structures or projecting structures have a maximum height Rz of 1,000 μm or less.

10. A light diffusion plate as set forth in claim 9, wherein said recessed structures or projecting structures have pyramidal or truncated pyramidal shapes respectively.

11. A light diffusion plate as set forth in claim 9, wherein said patterned part has repeated projecting structures, and said projecting structures are formed by cutting into a prism array having a plurality of linear prisms along a direction perpendicularly intersecting the longitudinal direction of said linear prisms in V-cross-sectional shapes.

12. A light diffusion plate as set forth in claim 9, wherein said patterned part has repeated recessed structures, and said recessed structures are transferred using a member having projecting structures formed by cutting into a prism array having a plurality of linear prisms along a direction perpendicularly intersecting the longitudinal direction of said linear prisms in V-cross-sectional shapes.

13. A backlight device comprising said light diffusion plate as set forth in claim 1.
